(19) United States
(12) Patent Application Publication
(10) Pub. No.: US 2005/0280856 A1
(43) Pub. Date: Dec. 22, 2005

(54) Printer driver and printing device supporting history functionality and method of restoring value of item using the history functionality

(76) Inventors: Young-ju Kim, Suwon-si (KR); Sang-hyup Lee, Suwon-si (KR)

Correspondence Address: STANZIONE & KIM, LLP, 919 18TH STREET, N.W., SUITE 440, WASHINGTON, DC, 20006, US

(21) Appl. No.: 11/146,068

(22) Filed: Jun. 7, 2005

(30) Foreign Application Priority Data
Jun. 16, 2004 (KR) 2004-44507

(51) Int. Cl. G06F 15/00

(52) U.S. Cl. 358/1.13

(57) ABSTRACT

A method of restoring a value of an item in a printer driver having a graphic user interface (GUI) including a plurality of items for print options includes sequentially storing values of previously set items, selecting one of the stored previously set item values, and moving to a screen showing the selected item value. In the selecting of a predetermined value, a desired item value is selected by moving in a reverse order of the item values stored lastly using a shortcut key.

### CROSS-REFERENCE TO RELATED APPLICATIONS

This application claims the priority under 35 U.S.C. § 119 of Korean Patent Application No. 10-2004-44507, filed on Jun. 16, 2004, in the Korean Intellectual Property Office, the disclosure of which is incorporated herein in its entirety by reference.

### BACKGROUND OF THE INVENTION

1. Field of the Invention

The present general inventive concept relates to a printer driver, and more particularly, to a printer driver and a printing device to support a history functionality, and a method of restoring a value of an item using the history functionality.

2. Description of the Related Art

A driver that is needed to drive an image forming apparatus, such as a printer, includes items corresponding to print options, such as a number of copies to be printed, a water mark, color attributes, a color range, a resolution (DPI), and print quality.

FIG. 1 illustrates an example of a graphic user interface (GUI) 100 of a conventional printer driver. The GUI 100 includes print menus in tabs including paper/quality, completion, effect, default, and so on, and items included in each of the print menus.

Referring to FIG. 1, the GUI 100 of the conventional printer driver includes the print menus, such as paper/quality, completion, effect, default, color, service, and information. As illustrated in FIG. 1, the color menu is activated and includes various items corresponding to print options, such as a color option, color attributes, and color ranges. In order to modify values of the items, a user selects the items of each of the print menus and changes the values of the items. After changing the values of the items, a user presses an “APPLY” button and the changed values are set as the changed values. Also, to set each item value as a default value, the user can press a “SET TO DEFAULT VALUE” button (not shown) provided by the printer driver, and the default values set by a manufacturer are restored.

However, when using the GUI 100 of the conventional print driver, it is inconvenient for the user to change the default item values because the user needs to click each menu and then change the items to of each menu.

### SUMMARY OF THE INVENTION

The present general inventive concept provides a printer driver in which a history display portion in a pull-down menu format is separately included in a graphic user interface (GUI) thereof so that a user can see a list of items that the user set previously, and a method of restoring a value of an item by directly moving to the item.

Also, the present general inventive concept provides a method of restoring values of items by moving to previous items from a most recently corrected item, or moving reversely, using a redo key or an undo key.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing a method of restoring a value of an item in a printer driver having a graphic user interface (GUI) including a plurality of items corresponding to print options, the method comprising sequentially storing values of previously set items, selecting a predetermined value of the stored item values, and moving to a screen showing the selected item value. The selecting of a predetermined value may comprise displaying the sequentially stored item values in a predetermined manner.

In the selecting of the predetermined value, a desired item value may be selected by moving in a reverse order of the item values stored lastly using a shortcut key, and when there is an item value stored after a present item value, the desired item value may be selected using a shortcut key.

The shortcut key may exist in the graphic user interface of the printer driver. The predetermined manner may be one of a last input first output (LIFO) manner and a first input first output (FIFO) manner.

The foregoing and/or other aspects and advantages of the present general inventive concept may also be achieved by providing a printer driver having a graphic user interface (GUI) including a plurality of items corresponding to print options, the graphic user interface comprising a history display portion that displays previously set item values in a predetermined manner.

The foregoing and/or other aspects and advantages of the present general inventive concept may also be achieved by providing a printing device including an operation panel, the operation panel comprising a display portion that displays values of previously set items corresponding to print options in a predetermined manner, and a shortcut key that restores the values of the items by moving to one of the item values.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view illustrating a graphic user interface of a conventional printer driver;

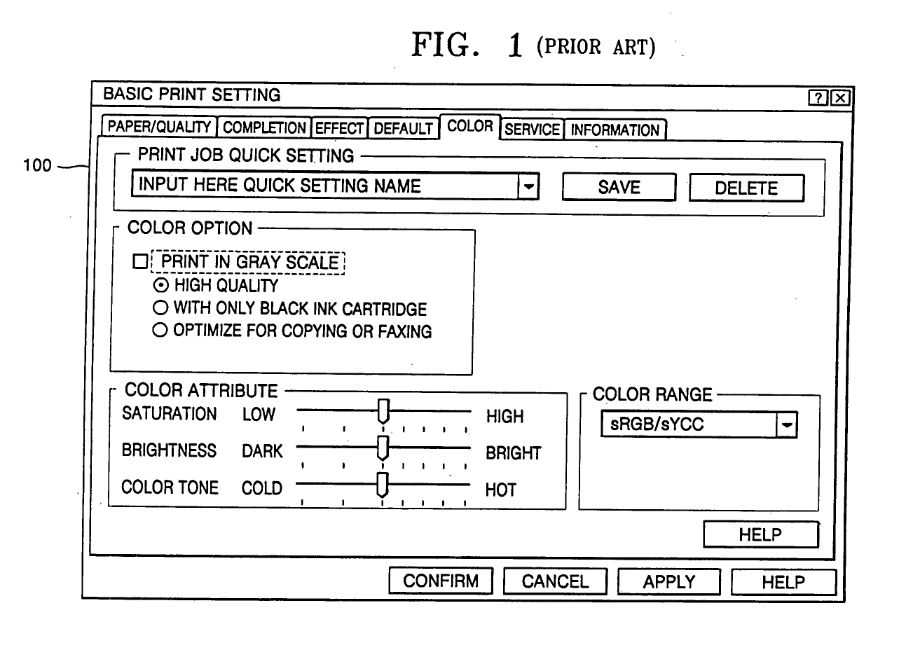

FIG. 2A is a view illustrating a graphic user interface of a printer driver according to an embodiment of the present general inventive concept which includes shortcut keys (a redo key and an undo key) and a history display portion;

FIG. 2B is a view illustrating an operation panel according to an embodiment of the present general inventive concept;

FIG. 3 is a block diagram illustrating a configuration of a printer according to an embodiment of the present general inventive concept and a computer connected thereto; and

FIG. 4 is a flow chart illustrating a method of changing values of items according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

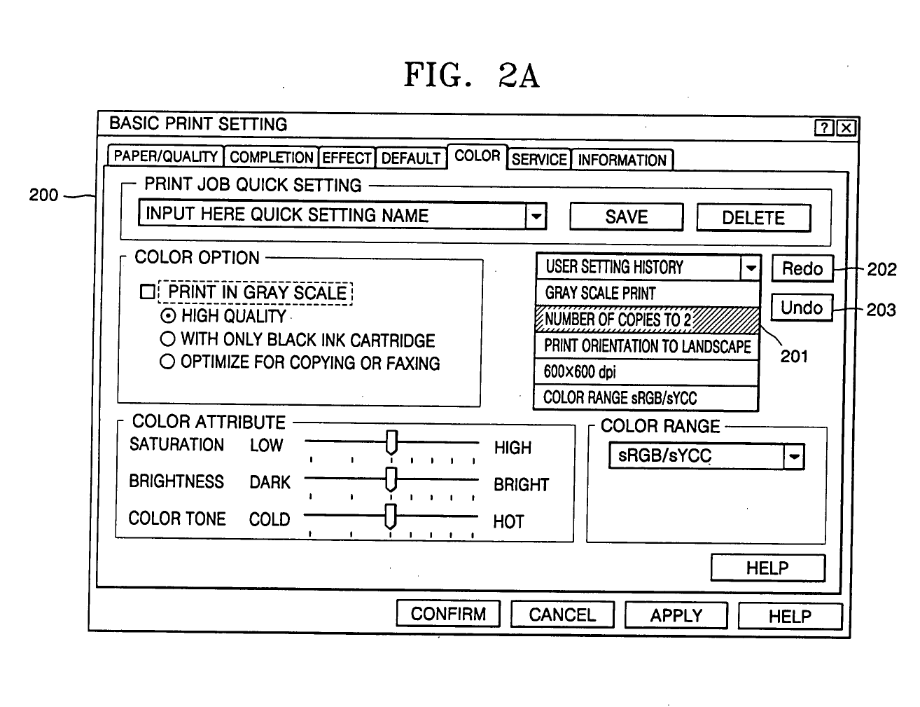

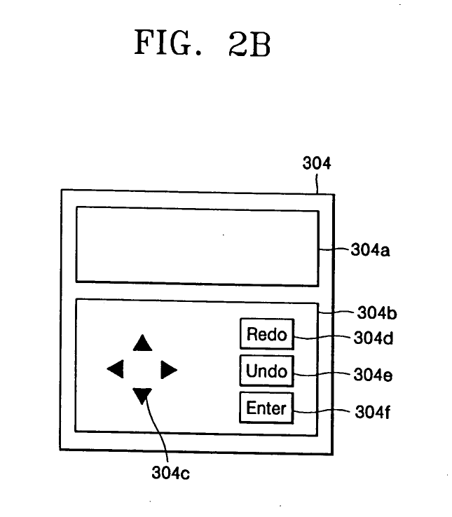

FIG. 2A illustrates a graphic user interface (GUI) 200 of a printer driver according to an embodiment of the present general inventive concept. Referring to FIG. 2A, the graphic user interface (GUI) 200 includes tab menus (paper/quality, completion, effect, default, color, service, and information) each containing items corresponding to print options. For example, the color tab menu, as illustrated in FIG. 2A, includes a print job quick setting item, a color option item, a color attribute item, and a color range item. Although the tab menus of paper/quality, completion, effect, default, color, service, and information are illustrated in FIG. 2A, the present general inventive concept is not limited thereto. The GUI 200 also includes a history display portion 201. The history display portion 201, as illustrated in FIG. 2A, is in a pull-down menu format. The history display portion 201 lists items of the tab menus that were previously set by a user in a predetermined fashion. For example, as shown in FIG. 2A, a the color option item (set to gray scale print), a number of copies item (set to 2), a print orientation item (set to landscape), a resolution item (set to 600×600 dpi), and the color range item (set to sRGB/sYCC) are listed in the history display portion 201 in order.

The history display portion 201 may be included in each of tab menus, as shown in FIG. 2A, or provided as a separate tab menu with a name of “HISTORY”. The items listed in the history display portion 201 can be listed in a last input first output (LIFO) or first input first output (FIFO) manner. In FIG. 2A, two shortcut keys, an undo key 202 and a redo key 203, are displayed. The undo key 202 reverses a most recent change to an item made by a user, and the redo key 203 reinstates the most recent change reversed by the undo key 202.

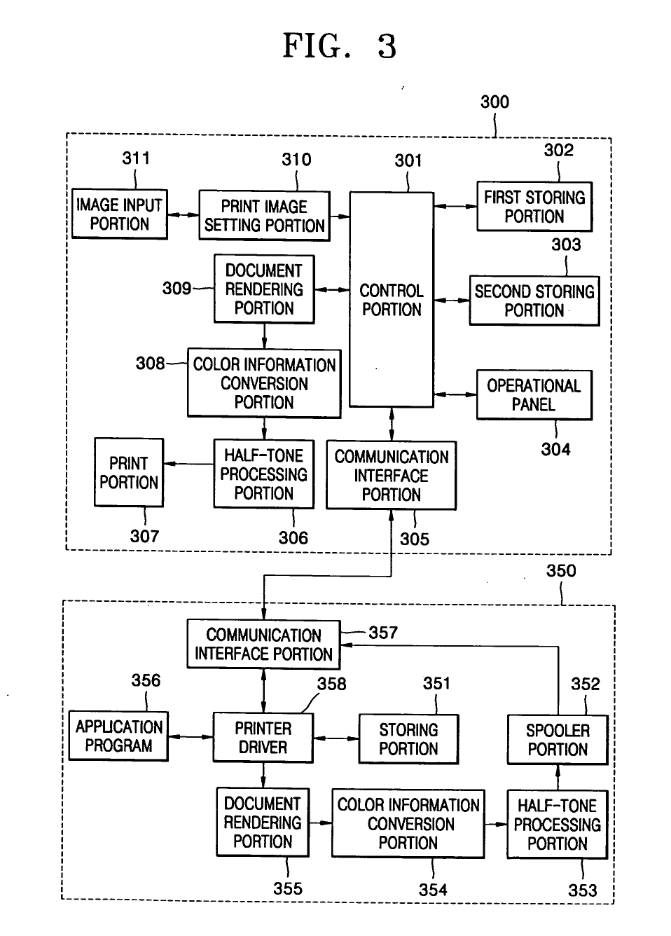

FIG. 3 illustrates a configuration of a printer 300 according to an embodiment of the present general inventive concept and a computer 350 connected thereto. Referring to FIG. 3, the printer 300 includes a control portion 301, a first storing portion 302, a second storing portion 303, and an operating panel equipment (OPE) 304. The printer 300 may further include a communication interface portion 305 to receive data to be printed from the computer 350 and a print portion 307 to print the data.

A document rendering portion 309 may be included in the printer 300. In this case, a memory card can be inserted into an image input portion 311. A print image set portion 310 sets a print image received from the memory card. The document rendering portion 309 performs rendering of the print image in units of dots. The rendered print image is converted by a color information conversion portion 308 to color information corresponding thereto, half-tone processed by a half-tone processing portion 306, and printed by the print portion 307 on print paper.

FIG. 2B illustrates the OPE 304 of the printer 300. Referring to FIGS. 2A through 3, the OPE 304 includes a display portion 304a and an input portion 304b. The display portion 304a displays the GUI 200 of FIG. 2A. When a user changes a value of one of the items of the GUI 200 displayed in the display portion 304a, the input portion 304b generates key data corresponding to the value of the item and transfers the key data to the control portion 301 of the printer 300. The input portion 304b includes four directional keys 304c, shortcut keys including an redo key 304d and an undo key 304e, and an enter key 304f, so that a user can control the GUI 200 from the input portion 304b to change and restore the values of the items of the GUI 200 displayed in the display portion 304a.

The first storing portion 302 can be a non-volatile RAM (NVRAM) to store values of the items changed by the user when a power of the printer 300 is off. The second storing portion 303 can be a temporary storing portion to store the key data generated by the OPE 304 in a predetermined manner. The predetermined manner may be either a last input first output (LIFO) manner or a first input first output (FIFO) manner.

The control portion 301 receives the key data generated from the OPE 304, temporarily stores the received key data in the second storing portion 304, and finally stores the key data in the first storing portion 302. Also, the control portion 301 generally controls operations of the printer 300, which are described in greater detail below.

The computer 350 can include a storing portion 351, a spooler portion 352, a half-tone processing portion 353, a color information conversion portion 354, a document rendering portion 355, an application program 356, a communication interface portion 357, and a printer driver 358.

A document created using the application program 356 is rendered by the document rendering portion 355 in units of dots. The rendered document is converted by the color information conversion portion 354 to corresponding color information. The color information is half-tone processed by the half-tone processing portion 404 and transferred to the printer 300 via the spooler portion 352 and the communication interface portion 357.

The printer driver 358 includes the GUI 200 of FIG. 2A and the GUI 200 includes the history display portion 201. The user can control the GUI 200 from the computer 350 to reverse or reinstate the changes to the items listed in the history display portion 201, using the shortcut keys, such as the redo key 203 and the undo key 202. The storing portion 351 stores the values of the items changed by the user in a predetermined manner and displays the changed items on the history display portion 201. The predetermined manner may be either a last input first output (LIFO) manner or a first input first output (FIFO) manner.

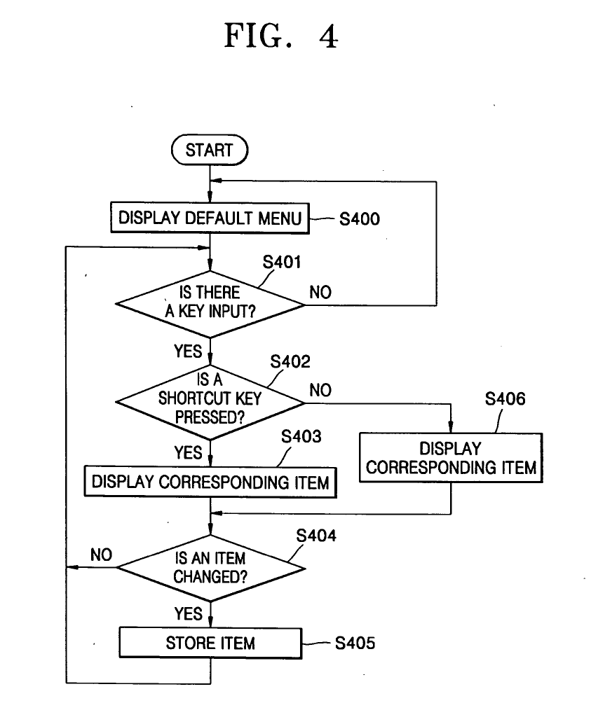

FIG. 4 is a flow chart illustrating a method of changing the values of items of the GUI 200 according to an embodiment of the present general inventive concept. Referring to FIGS. 2A-4, when a user presses a print button after editing a document using the application program 356, the GUI 200 is displayed (S400) with the items if the GUI set to predetermined default values.

The GUI 200 can include the history display portion 201 in a pull-down menu format as illustrated in FIG. 2A. The history display portion 201 displays values of the items set or changed by the user.

Next, it is determined whether a key of the GUI 200 is input (S401). When the input key is a shortcut key (S402), a selected item in the history display portion 201 is displayed by being highlighted (S403). For example, in FIG. 2A, the number of copies item is highlighted. The item can be highlighted by reversing or flickering the item.

For example, assuming that, as shown in the history display portion 201 of FIG. 2, the item that the user set or changed most recently is a setting the color option item to gray scale print and the items changed preceding the color option item are sequentially setting the number of copies item to 2 and the print orientation item to landscape. If a pressed shortcut key is the undo key 203, the item “Setting the number of copies to 2” is displayed by being inversed in the history display portion 201, as shown in FIG. 2A.

Next, when the user changes the value of the selected item (S404), the changed item value is stored (S405) and the history display portion 201 is updated accordingly. If the item value is not changed, the system goes back to operation S401 and waits for a key to be input.

If the input key in operation S402 is not a shortcut key, the tab menu selected by the user is displayed (S406) and the values of the items of the selected tab menu can be set or changed. Likewise, the set or changed values are stored (S405) and the history display portion 201 is updated accordingly.

As described above, when a user needs to change a value of an item set in a printer driver, a user can move to the item and change the value of the item using the shortcut keys such as an undo key and a redo key. Also, the user can click a history display portion in a pull-down menu format included in the printer driver and move to one of the items listed in the history display portion by selecting the item to change the item value.

In particular, when an item is set as a slide type, like the color attribute item of FIG. 2A, a previous setting value can be effectively restored.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A method of restoring a value of an item in a printer driver having a graphic user interface (GUI) including a plurality of items corresponding to print options, the method comprising:
sequentially storing values of the items previously set;
selecting one of the stored previously set item values; and
moving to a screen showing the selected item value.

2. The method as claimed in claim 1, wherein the selecting of the one of the stored previously set item values comprises displaying the sequentially stored item values in a predetermined manner.

3. The method as claimed in claim 2, wherein, the selecting of the one of the stored previously set item values comprises selecting a desired item value by moving in a reverse order of the item values stored lastly using a shortcut key.

4. The method as claimed in claim 2, wherein, the selecting the one of the stored previously set item values comprises selecting a desired item value using a shortcut key when there is an item value stored after a present item value.

5. The method as claimed in claim 2, wherein the predetermined manner is one of a last input first output (LIFO) manner and a first input first output (FIFO) manner.

6. The method as claimed in claim 1, wherein, the selecting of the one of the stored previously set item values comprises selecting a desired item value by moving in a reverse order of the item values stored lastly using a shortcut key.

7. The method as claimed in claim 6, wherein the selecting of the one of the stored previously set item values comprises displaying a graphic user interface to display the shortcut key to select the one of the stored previously set item values from the graphic user interface.

8. The method as claimed in claim 1, wherein, the selecting of the one of the stored previously set item values comprises selecting a desired item value using a shortcut key when there is an item value stored after a present item value.

9. The method as claimed in claim 8, wherein the selecting of the one of the stored previously set item values comprises displaying a graphic user interface to display the shortcut key to select the one of the stored previously set item values from the graphic user interface.

10. The method as claimed in claim 1, further comprising storing the selected item value.

11. A method of updating print options of an image forming apparatus, the method comprising:
displaying a history of changes of a plurality of previously changed print options.

12. The method as claimed in claim 11, further comprising:
selecting one or more of the displayed previously changed print options; and
updating print options according to the selected previously changed print options.

13. The method as claimed in claim 12, wherein the selecting of the one or more of the displayed previously changed print options comprises:
selecting the one or more of the displayed previously changed print options using one of an undo shortcut key and a redo shortcut key.

14. The method as claimed in claim 13, wherein when the redo key is used to select the one or more of the displayed previously changed print options, the updating of the print options comprises:
reinstating a the previously made change to the corresponding print options.

15. The method as claimed in claim 12, further comprising:
updating the history of previously changed print options when the print options are updated.

16. The method as claimed in claim 12, wherein the updating of the print options comprises:
displaying a menu corresponding to the selected previously changed print options; and
changing the corresponding print options by controlling the displayed menu.

17. The method as claimed in claim 11, wherein the displaying of the history of previously changed print options comprises:
displaying most recent changes first.

18. The method as claimed in claim 11, wherein the displaying of the history previously changed print options comprises:
displaying most recent changes last.

19. A printer driver having a graphic user interface (GUI) including a plurality of items corresponding to print options, the graphic user interface comprising:
a history display portion to display previously set item values in a predetermined manner.

20. The printer driver as claimed in claim 19, wherein the history display portion comprises a shortcut key to move in a reverse order of the item values to select a desired item value.

21. The printer driver as claimed in claim 20, wherein the history display portion displays the shortcut key.

22. The printer driver as claimed in claim 19, wherein the item values comprise an item value stored after a present item value, and the history display portion comprises a shortcut key to select a desired item value.

23. The printer driver as claimed in claim 22, wherein the history display portion displays the shortcut key.

24. The printer driver as claimed in claim 19, wherein the history display portion displays a selected item value by highlighting the item value.

25. The printer driver as claimed in claim 19, wherein the predetermined manner is one of a last input first output (LIFO) manner and a first input first output (FIFO) manner.

26. An image forming apparatus to perform a printing operation comprising a graphic user interface (GUI), the GUI comprising:
a history display portion to display a history of changes to a plurality of print options of a plurality of print menus.

27. A printing device including an operation panel, the operation panel comprising:
a display portion to display values of previously set items with respect to print options in a predetermined manner; and
a shortcut key to restore the values of the items to the previously set values by moving to one of the items.

28. The printing device as claimed in claim 27, wherein the shortcut key moves in a reverse order of the item values stored lastly to select a desired item value.

29. The printing device as claimed in claim 27, wherein the values of the previously set items comprise an item value stored after a present item value, and a desired item value is selected using the shortcut key.

30. The printing device as claimed in claim 27, wherein the predetermined manner is one of a last input first output (LIFO) manner and a first input first output (FIFO) manner.

31. An image forming apparatus, comprising:
an operation panel comprising:
a display portion displaying a history display thereon, the history display displaying a history of changes previously made to print options, and
an input portion to select changes from the history of changes displayed in the history display;
a print portion to print an image; and
a control portion to control the display portion and the print portion according to the change selected from the history of changes by the input portion.

32. A computer readable recording medium containing a method of updating print options of an image forming apparatus, the method comprising: displaying a history of changes of a plurality of previously changed print options.
